(19) United States
(12) Patent Application Publication
(10) Pub. No.: US 2026/0163625 A1
(43) Pub. Date: Jun. 11, 2026

(54) Terminal, System, and Method for Performing a Channel State Information (CSI) Report Activation or Deactivation Procedure

(71) Applicant: Apple Inc., Cupertino, CA (US)

(72) Inventors: Hong He, San Jose, CA (US); Dawei Zhang, Saratoga, CA (US); Wei Zeng, Saratoga, CA (US); Ankit Bhamri, Haar (DE); Haitong Sun, Saratoga, CA (US); Chunhai Yao, Beijing (CN); Seyed Ali Akbar Fakoorian, San Diego, CA (US); Huaning Niu, San Jose, CA (US); Chunxuan Ye, San Diego, CA (US); Jie Cui, San Jose, CA (US)

(21) Appl. No.: 19/127,058

(22) PCT Filed: Nov. 4, 2022
(86) PCT No.: PCT/CN2022/129794

§ 371 Date: May 2, 2025

(51) Int. Cl. H04B 7/06; H04W 24/10; H04W 72/21

(52) U.S. Cl. CPC H04B 7/0626; H04W 24/10; H04W 72/21

(57) ABSTRACT

A terminal may include a receiver configured to receive multiple information parameters indicating a cell group (CG) configuration, cell configurations corresponding to candidate cells in a CG, and a Channel State Information (CSI) report configuration for the candidate cells in the CG. The terminal may include a processor configured to determine multiple indicators identifying the CG, the candidate cells in the CG, and multiple CSI reports for the candidate cells in the CG based on the information parameters. The processor may be configured to perform a CSI report activation/deactivation procedure that indicates CSI reports to activate or deactivate for the candidate cells in the CG based on the indicators.

### FIELD

The present application relates to wireless devices and wireless networks, including devices, circuits, and methods for performing a Channel State Information (CSI) report procedure in which CSI reports are activated or deactivated for one or one or more candidate cells in a cell group (CG).

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

### SUMMARY

In accordance with one or more embodiments, a terminal includes a receiver configured to receive multiple information parameters indicating a cell group (CG) configuration, cell configurations corresponding to candidate cells in a CG, and a Channel State Information (CSI) report configuration for the candidate cells in the CG. Further, the terminal includes a processor configured to determine multiple indicators identifying the CG, the candidate cells in the CG, and multiple CSI reports for the candidate cells in the CG based on the information parameters. The processor is configured to perform a CSI report activation/deactivation procedure that indicates CSI reports to activate or deactivate for the candidate cells in the CG based on the indicators.

The techniques described herein may be implemented in and/or used with a number of different types of devices, including but not limited to cellular phones, wireless devices, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates an example block diagram of a UE, according to some aspects.

FIG. 3 illustrates an example block diagram of a BS, according to some aspects.

FIG. 4 illustrates an example block diagram of wireless communication circuitry, according to some aspects.

FIG. 5 is a code example for configuring a Channel State Information (CSI) report activation/deactivation procedure, according to some aspects.

FIG. 6 is a table illustrating examples of signaling techniques in the CSI report activation/deactivation procedure, according to some aspects.

FIG. 7 is a table illustrating examples of signaling techniques in the CSI report activation/deactivation procedure, according to some aspects.

FIG. 8 is a code example for performing the CSI report activation/deactivation procedure, according to some aspects.

FIG. 9 is a diagram illustrating an example of signaling techniques in the CSI report activation/deactivation procedure, according to some aspects.

FIG. 10 is a diagram illustrating an example of signaling format techniques in the CSI report activation/deactivation procedure, according to some aspects.

FIG. 11 is a flowchart detailing a method of performing the CSI report activation/deactivation procedure, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

There is a need to study mobile services that require low-latency and high reliability performance (i.e., ultra-reliable low latency communications (URLLC)). The evolution of the 5G and New Radio (NR) standards need to continuously enhance the mobility robustness performance for these challenging scenarios. In one or more embodiments, Inter-Cell Beam Management (ICBM) in 5G NR is enhanced to allow a full flexibility of handover operations across multiple layers. In one or more embodiments, this disclosure is directed towards configuration designs for Layer 1 (L1) measurements and Channel State Information (CSI) reports for deactivated candidate cells, which are used to address L1/Layer 2 (L2)-based handover operations. In this regard, embodiments discussed herein improve the ICBM framework to support L1/L2 inter-cell mobility for intra-DU, intra-frequency, and inter-frequency operations. In other embodiments, this disclosure is directed towards improving the configuration of CSI reports in the ICBM.

In accordance with one or more embodiments, a user equipment (UE) device or terminal communicating with other terminals (other wireless communication devices, network devices, UE devices, and/or Base Station (BS) devices) may perform radio transmissions including the low-latency and high reliability performance operations described in this disclosure. The L1 enhancements for ICBM may include improvements in L1 measurement, L1 reporting, and L1/L2 beam indication. In some embodiments, the ICBM starts L1-based measurements with CSI measurements. Further, the intra-frequency and/or inter-frequency L1 measurements are supported by Synchronization Signal Blocks (SSBs).

L1 measurements may be classified in different reported measurement types such as intra-frequency, inter-frequency, inter-system, traffic volume, quality and internal measurements for the UE device. In the LI measurements, the UE device may be configured with CSI-Reference Signal (RS), SSB, or CSI-RS and SSB resources. The measurements may be performed for a serving cell (i.e., PCell, PSCell, or SCell) on the resources configured for L1-RSRP measurements within an active Bandwidth Part (BWP).

In one or more embodiments, the UE device may configure the L1 measurements for multiple cells in a cell group (CG). The UE device may configure the L1 measurements upon receiving multiple information parameters including indicators of a CG configuration, multiple cell configurations corresponding to one or more candidate cells in the CG, and a CSI report configuration for the candidate cells in the CG. In some embodiments, multiple indicators are used to identify the CG, the candidate cells in the CG, and multiple CSI reports for the candidate cells in the CG based on the information parameters. The UE device may perform a CSI report activation/deactivation procedure that indicates multiple CSI reports to activate or deactivate candidate cells in the CG based on the indicators.

In one or more embodiments, the UE device may be configured to receive a cell switching command that triggers a cell switching operation in which communication with the UE device is switched from a current serving cell to one of the candidate cells. In this regard, the UE device may perform the cell switching operation in accordance with the CG configuration, the cell configurations, or the CSI report configurations. In some embodiments, the CSI report activation/deactivation procedure includes activating CSI resource sets that are associated with the CSI report configuration.

The following is a glossary of terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, PlayStation Vita™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

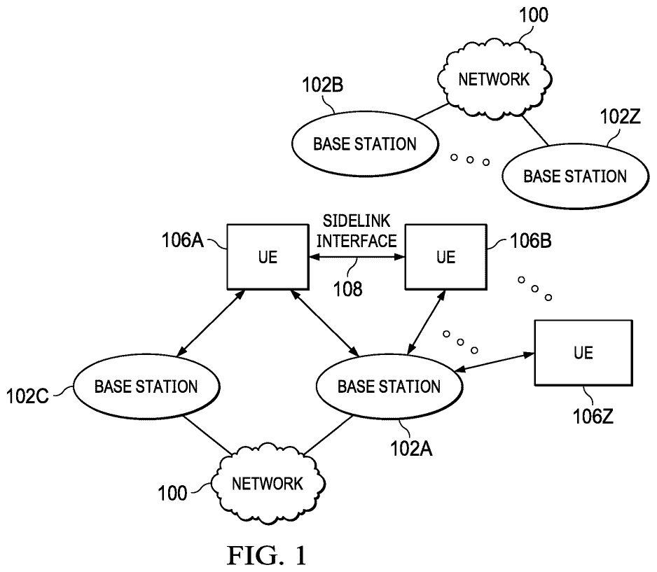

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106Z. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106Z.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (VUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weatherpr23 enclosure suitable for outdoor installation, and may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106Z and similar devices over a geographic area via one or more cellular communication standards.

Thus, while base station 102A may act as a “serving cell” for UEs 106A-106Z as illustrated in FIG. 1, each UE 106 may also be capable of receiving signals from (and possibly within communication range of) one or more other cells (which may be provided by base stations 102B-102Z and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102Z may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA 2000 (1xRTT /1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Beam Reporting for L1/L2-Based Cell Switching in Wireless Communication

As described above, in some embodiments described herein, the L1 enhancements for ICBM may include improvements in L1 measurement, L1 reporting, and L1/L2 beam indication. L1 measurements may be classified in different reported measurement types such as intra-frequency, inter-frequency, inter-system, traffic volume, quality and internal measurements for the UE device. In the L1 measurements, one of the UEs 106 may be configured with CSI-RS, SSB, or CSI-RS and SSB resources. The measurements may be performed for one of the other UEs 106 acting as a serving cell (i.e., PCell, PSCell, or SCell) on the resources configured for L1-RSRP measurements within an active BWP.

For example, the UE 106A may configure the LI measurements for some of the UEs 106B-106Z acting as multiple cells in a CG. The UE 106A may configure the L1 measurements upon receiving multiple information parameters (i.e., configuration parameters received via higher layer signaling) including indicators of a CG configuration, multiple cell configurations corresponding to one or more candidate cells in the CG, and a CSI report configuration for the candidate cells in the CG. The CG configuration may affect all UEs 106B-106Z while the cell configurations may be individual cell configurations for candidate UEs among the UEs 106B-106Z. Further, the CSI report configuration may set up reporting for the CSI reports from the candidate UEs.

In one or more embodiments, the multiple indicators are used to identify the CG, the candidate cells in the CG, and multiple CSI reports for the candidate cells in the CG based on the information parameters. The UE 106A may perform a CSI report activation/deactivation procedure that indicates multiple CSI reports to activate or deactivate candidate cells in the CG based on the indicators.

In one or more embodiments, the UE 106A may be configured to receive a cell switching command from the network 100 that triggers a cell switching operation in which communication with the UE device is switched from a current serving cell (i.e., UE 106B) to one of the candidate cells (i.e., one of UEs 106B-106Z). In this regard, the UE 106A may perform the cell switching operation in accordance with the CG configuration, the individual cell configurations, or the CSI report configurations. In some embodiments, the CSI report activation/deactivation procedure includes activating CSI resource sets that are associated with the CSI report configuration.

As described above, the CSI report activation/deactivation procedure is enhanced herein to improve beam level mobility for the UE 106A. Beam Level Mobility does not require explicit Radio Resource Control (RRC) signaling to be triggered. Beam level mobility may occur within a cell, or between cells (i.e., ICBM). For ICBM, the UE 106A may receive or transmit UE dedicated channels/signals via a Total Radiated Power (TRP) associated with a Physical Cell ID (PCI) different from the PCI of a serving cell, while non-UE-dedicated channels/signals may be received via a TRP associated with a PCI of the serving cell. In this regard, the network 100 may provide via RRC signaling the UE 106A with measurement configuration containing configurations of SSB/CSI resources and resource sets, reports and trigger states for triggering channel and interference measurements and reports. In case of ICBM, a measurement configuration includes SSB resources associated with PCIs different from the PCI of a serving cell. In this regard, Beam Level Mobility is dealt with at lower layers by means of physical layer and Medium Access Control (MAC) layer control signaling, and RRC is not required to know which beam is being used at a given point in time.

SSB-based Beam Level Mobility is based on the SSB associated to the initial downlink (DL) BWP and may be configured for the initial DL BWPs and for DL BWPs containing the SSB associated to the initial DL BWP. For other DL BWPs, Beam Level Mobility may be performed based on CSI-RS. Beam Level Mobility may be additionally configured in the manner described in reference to 3GPP TS 38.300.

In one or more embodiments, for CSI-RS resource sets associated with Resource Settings configured with higher layer parameter (i.e., such as the information element resourceType) set to “aperiodic,” “periodic,” or “semi-persistent,” trigger states for Reporting Setting(s) (i.e., configured with the higher layer parameter reportConfigType set to “aperiodic”) and/or Resource Setting for channel and/or interference measurement on one or more component carriers are configured using the higher layer parameter CSI-AperiodicTriggerStateList. For aperiodic CSI report triggering, a single set of CSI triggering states may be configured via higher layer signaling, in which the CSI triggering states may be associated with any candidate DL BWP. In this case, the UE 106A may not be expected to receive more than one DCI with non-zero CSI request per slot. The UE 106A may not be configured with different state IDs for a same aperiodic CSI-RS resource ID configured in multiple aperiodic CSI-RS resource sets with a same triggering offset in the same aperiodic trigger state. The aforementioned information elements and the CSI-RS configuration may be additionally implemented in the manner described in reference to 3GPP TS 38.212, TS 38.214, and TS 38.331.

### Example Communication Device

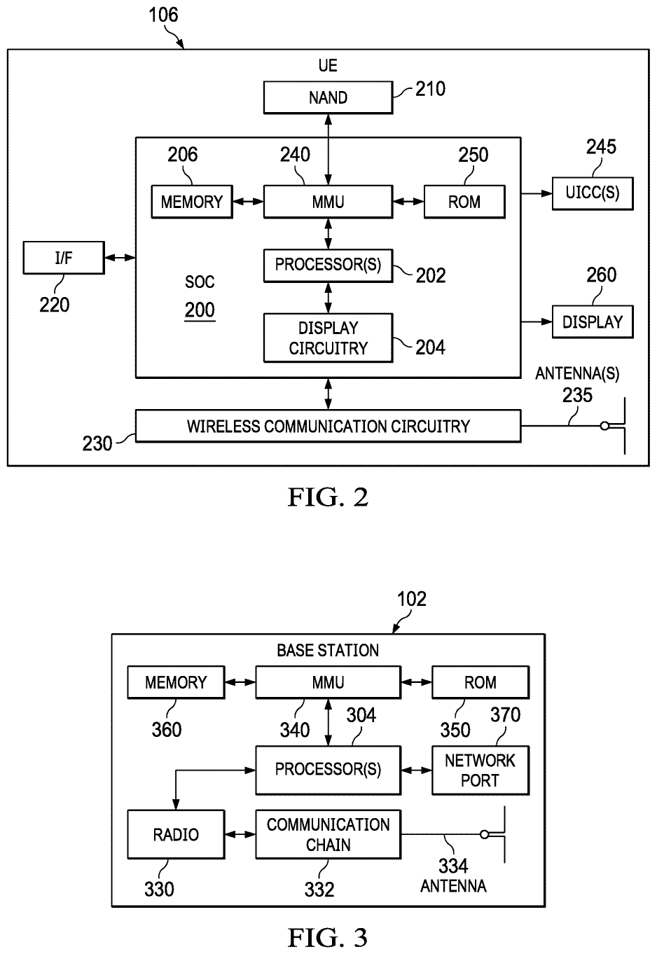

FIG. 2 illustrates an example simplified block diagram of a communication device 106, according to some aspects. It is noted that the block diagram of the communication device of FIG. 2 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 200 configured to perform core functions. For example, this set of components may be implemented as a system on chip (SOC), which may include portions for various purposes. Alternatively, this set of components 200 may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 210), an input/output interface such as connector I/F 220 (e.g., for connecting to a computer system; dock; charging station; input devices, such as a microphone, camera, keyboard; output devices, such as speakers; and the like), the display 260, which may be integrated with or external to the communication device 106, and wireless communication circuitry 230 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 230 may couple (e.g., communicatively; directly or indirectly) to one or more antennas, such as antenna(s) 235 as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 230 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 230 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mm Wave frequencies. As mmWave systems operate in higher frequencies than typically found in LTE systems, signals in the mm Wave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 245 that include Subscriber Identity Module (SIM) functionality, such as one or more Universal Integrated Circuit Card(s) (UICC(s)) cards 245.

As shown, the SOC 200 may include processor(s) 202, which may execute program instructions for the communication device 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, wireless communication circuitry 230, connector I/F 220, and/or display 260. The MMU 240 may be configured to perform memory protection and page table translation or set up. In some aspects, the MMU 240 may be included as a portion of the processor(s) 202.

As noted above, the communication device 106 may be configured to communicate using wireless and/or wired communication circuitry. As described herein, the communication device 106 may include hardware and software components for implementing any of the various features and techniques described herein. The processor 202 of the communication device 106 may be configured to implement part or all of the features described herein (e.g., by executing program instructions stored on a memory medium). Alternatively (or in addition), processor 202 may be configured as a programmable hardware element, such as a Field Programmable Gate Array (FPGA), or as an Application Specific Integrated Circuit (ASIC). Alternatively (or in addition) the processor 202 of the communication device 106, in conjunction with one or more of the other components 200, 204, 206, 210, 220, 230, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, and the like) configured to perform the functions of processor(s) 202.

Further, as described herein, wireless communication circuitry 230 may include one or more processing elements. In other words, one or more processing elements may be included in wireless communication circuitry 230. Thus, wireless communication circuitry 230 may include one or more integrated circuits (ICs) that are configured to perform the functions of wireless communication circuitry 230. In addition, each integrated circuit may include circuitry (e.g., first circuitry, second circuitry, and the like) configured to perform the functions of wireless communication circuitry 230.

### Example Base Station

FIG. 3 illustrates an example block diagram of a base station 102, according to some aspects. It is noted that the base station of FIG. 3 is a non-limiting example of a possible base station. As shown, the base station 102 may include processor(s) 304 which may execute program instructions for the base station 102. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 102 may include at least one network port 370. The network port 370 may be configured to couple to a telephone network and provide a plurality of devices, such as UE devices 106, access to the telephone network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5GC network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 334, and possibly multiple antennas. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mm Wave, the 5G NR radio may be coupled to one or more mm Wave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 304 of the base station 102 may be configured to implement or support implementation of part or all of the methods described herein (e.g., by executing program instructions stored on a memory medium). Alternatively, the processor 304 may be configured as a programmable hardware element, such as a Field Programmable Gate Array (FPGA), or as an Application Specific Integrated Circuit (ASIC), or a combination thereof. Alternatively (or in addition) the processor 304 of the BS 102, in conjunction with one or more of the other components 330, 332, 334, 340, 350, 360, 370 may be configured to implement or support implementation of part or all of the features described herein.

In addition, as described herein, processor(s) 304 may include one or more processing elements. Thus, processor(s) 304 may include one or more integrated circuits (ICs) that are configured to perform the functions of processor(s) 304. In addition, each integrated circuit may include circuitry (e.g., first circuitry, second circuitry, and the like) configured to perform the functions of processor(s) 304.

Further, as described herein, radio 330 may include one or more processing elements. Thus, radio 330 may include one or more integrated circuits (ICs) that are configured to perform the functions of radio 330. In addition, each integrated circuit may include circuitry (e.g., first circuitry, second circuitry, and the like) configured to perform the functions of radio 330.

### Example Cellular Communication Circuitry

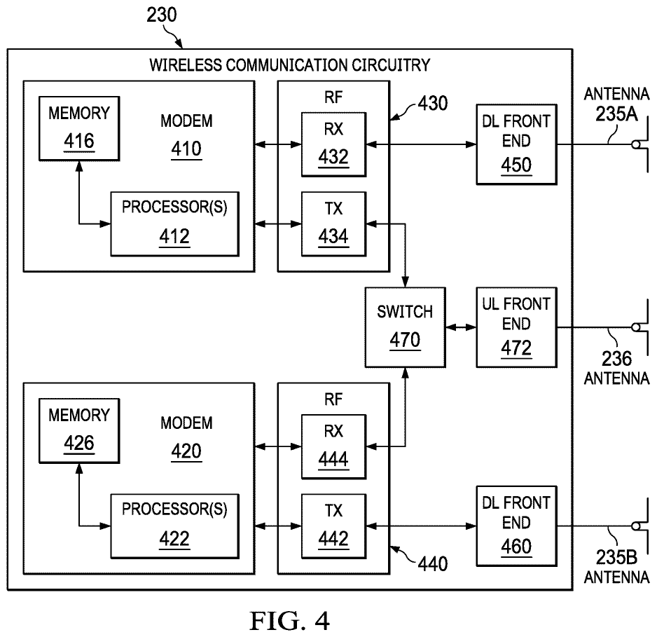

FIG. 4 illustrates an example simplified block diagram of cellular communication circuitry, according to some aspects. It is noted that the block diagram of the cellular communication circuitry of FIG. 4 is only one example of a possible cellular communication circuit; other circuits, such as circuits including or coupled to sufficient antennas for different RATs to perform uplink activities using separate antennas, or circuits including or coupled to fewer antennas (e.g., that may be shared among multiple RATs) are also possible. According to some aspects, cellular communication circuitry 230 may be included in a communication device, such as communication device 106 described above. As noted above, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 230 may couple (e.g., communicatively; directly or indirectly) to one or more antennas, such as antennas 235a, 235b, and 236 as shown. In some aspects, cellular communication circuitry 230 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 4, cellular communication circuitry 230 may include a first modem 410 and a second modem 420. The first modem 410 may be configured for communications according to a first RAT, e.g., such as LTE or LTE-A, and the second modem 420 may be configured for communications according to a second RAT, e.g., such as 5G NR.

As shown, the first modem 410 may include one or more processors 412 and a memory 416 in communication with processors 412. Modem 410 may be in communication with a radio frequency (RF) front end 430. RF front end 430 may include circuitry for transmitting and receiving radio signals. For example, RF front end 430 may include receive circuitry (RX) 432 and transmit circuitry (TX) 434. In some aspects, receive circuitry 432 may be in communication with downlink (DL) front end 450, which may include circuitry for receiving radio signals via antenna 235a.

Similarly, the second modem 420 may include one or more processors 422 and a memory 426 in communication with processors 422. Modem 420 may be in communication with an RF front end 440. RF front end 440 may include circuitry for transmitting and receiving radio signals. For example, RF front end 440 may include receive circuitry 442 and transmit circuitry 444. In some aspects, receive circuitry 442 may be in communication with DL front end 460, which may include circuitry for receiving radio signals via antenna 235b.

In some aspects, a switch 470 may couple transmit circuitry 434 to uplink (UL) front end 472. In addition, switch 470 may couple transmit circuitry 444 to UL front end 472. UL front end 472 may include circuitry for transmitting radio signals via antenna 236. Thus, when cellular communication circuitry 230 receives instructions to transmit according to the first RAT (e.g., as supported via the first modem 410), switch 470 may be switched to a first state that allows the first modem 410 to transmit signals according to the first RAT (e.g., via a transmit chain that includes transmit circuitry 434 and UL front end 472). Similarly, when cellular communication circuitry 230 receives instructions to transmit according to the second RAT (e.g., as supported via the second modem 420), switch 470 may be switched to a second state that allows the second modem 420 to transmit signals according to the second RAT (e.g., via a transmit chain that includes transmit circuitry 444 and UL front end 472).

As described herein, the first modem 410 and/or the second modem 420 may include hardware and software components for implementing any of the various features and techniques described herein. The processors 412, 422 may be configured to implement part or all of the features described herein, e.g., by executing program instructions stored on a memory medium (e.g., a non-transitory computer-readable memory medium). Alternatively (or in addition), processors 412, 422 may be configured as a programmable hardware element, such as an FPGA (Field Programmable Gate Array), or as an ASIC (Application Specific Integrated Circuit). Alternatively (or in addition) the processors 412, 422, in conjunction with one or more of the other components 430, 432, 434, 440, 442, 444, 450, 470, 472, 235 and 236 may be configured to implement part or all of the features described herein.

In addition, as described herein, processors 412, 422 may include one or more processing elements. Thus, processors 412, 422 may include one or more integrated circuits (ICs) that are configured to perform the functions of processors 412, 422. In addition, each integrated circuit may include circuitry (e.g., first circuitry, second circuitry, and the like) configured to perform the functions of processors 412, 422.

In some aspects, the cellular communication circuitry 230 may include only one transmit/receive chain. For example, the cellular communication circuitry 230 may not include the modem 420, the RF front end 440, the DL front end 460, and/or the antenna 235b. As another example, the cellular communication circuitry 230 may not include the modem 410, the RF front end 430, the DL front end 450, and/or the antenna 235a. In some aspects, the cellular communication circuitry 230 may also not include the switch 470, and the RF front end 430 or the RF front end 440 may be in communication, e.g., directly, with the UL front end 472.

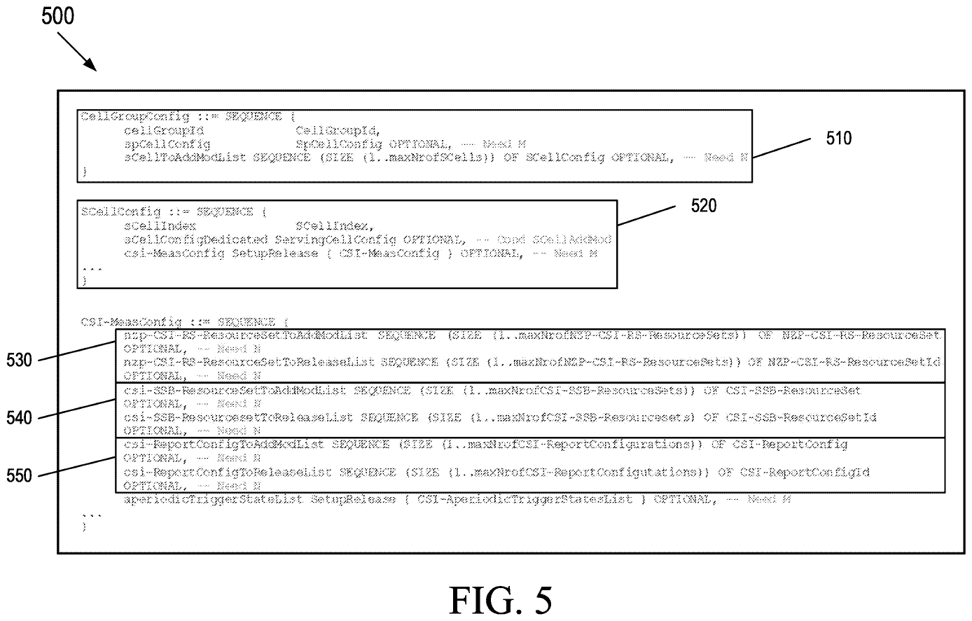

Turning to FIG. 5, a code example 500 illustrates a structure to configure CSI-RS resource sets, SSBs for L1 measurement, and the associated CSI reporting during a switch/handover preparation phase. In FIG. 5, multiple blocks 510-550 are shown where the ICBM framework is modified for L1 measurement configuration and reporting for candidate cell to trigger an L1/L2-based cell switch/handover procedure. During the switch/handover preparation phase, a terminal (i.e., such as one the UEs 106) may be configured with a set of candidate CGs where each CG consists of one or more candidate cells. Within each cell group, CSI reports may be configured as part of each candidate cell configuration by RRC signaling. Each candidate cell may be provided with a cell group index (i.e., CellGroupID) and an individual cell identifier (i.e., a sCell ID or sCellIndex) for the cell switching operation.

In some embodiments, within each CG, one candidate cell maybe configured as candidate PCell by a respective information elements, such as spcellConfig shown in block 510. Further, as shown in block 520, each CSI report may be identified by a CSI report ID. In addition, as shown in blocks 530-550, at least one TRS resource set may be configured in accordance with an aperiodic triggering state such that aperiodic TRS on a candidate cell is triggered by a cell switching command to achieve finer T/F tracking to receive the PDSCH.

The cell switching command may triggers a cell switching operation in which communication with the terminal is switched from a current serving cell to a candidate cell out of the available candidate cells. Further, the terminal may perform the cell switching operation in accordance with the CG configuration, the individual cell configurations, or the CSI report configuration. The CSI report activation/deactivation procedure may include activating one or more CSI resource sets that are associated with the CSI report configuration.

In FIG. 5, the code example 500 shows multiple information parameters indicating a CG configuration (i.e., CellGroupConfig in block 510), one or more cell configurations corresponding to one or more candidate cells in a CG (i.e., SCellConfig in block 520), and a CSI report configuration for the one or more candidate cells in the CG (i.e., CSI-MeasConfig in blocks 530-550). Upon receiving the information parameters shown in code example 500, the terminal may determine a first plurality of indicators from the code. At this point, based on the plurality of information parameters, the terminal may identify the CG, the individual candidate cells in the CG, and the CSI reports for the candidate cells in the CG. Based on the indicators, the terminal may perform a CSI report activation/deactivation procedure that indicates CSI reports of the CSI reports to activate or deactivate for the candidate cells in the CG.

In block 510, the information element CellGroupConfig information parameters (i.e., configuration parameters) from the network. This information element includes at least one special cell configuration (i.e., SpCellConfig). In some embodiments, the information element CellGroupId is used to identify a cell group. A value of 0 identifies a master cell group. Other values may identify secondary cell groups. Further, the information element SpCellConfig indicates parameters for the SpCell of this CG (i.e., PCell of MCG or PSCell of SCG). In addition to the aforementioned information elements, the block 510 includes sCellToAddModList to list a possible number of SCells or serving cells that may be added or modified.

In block 520, the information SCellConfig is used to configure candidate cells from multiple cells in a CG. Further, the information element SCellIndex is used to identify an SCell or PSCell across multiple CGs. In this block, the information element CSI-MeasConfig is set up.

In blocks 530-550, the information element CSI-MeasConfig is used to configure the CSI-RSs (i.e., reference signals) belonging to the serving cell in which the CSI-MeasConfig is included, channel state information reports to be transmitted on PUCCH on the serving cell in which CSI-MeasConfig is included, and channel state information reports on PUSCH triggered by DCI received on the serving cell in which CSI-MeasConfig is included. In the block 530, the CSI-RS resource for L1 measurement includes at least one TRS resource set on a candidate cell. Block 540 shows an SSB configured for L1 measurements while the block 550 shows a CSI report configuration

The information elements shown in blocks 510-550 may be additionally used and/or configurated in the manner described in 3GPP TS 38.214 and TS 38.331.

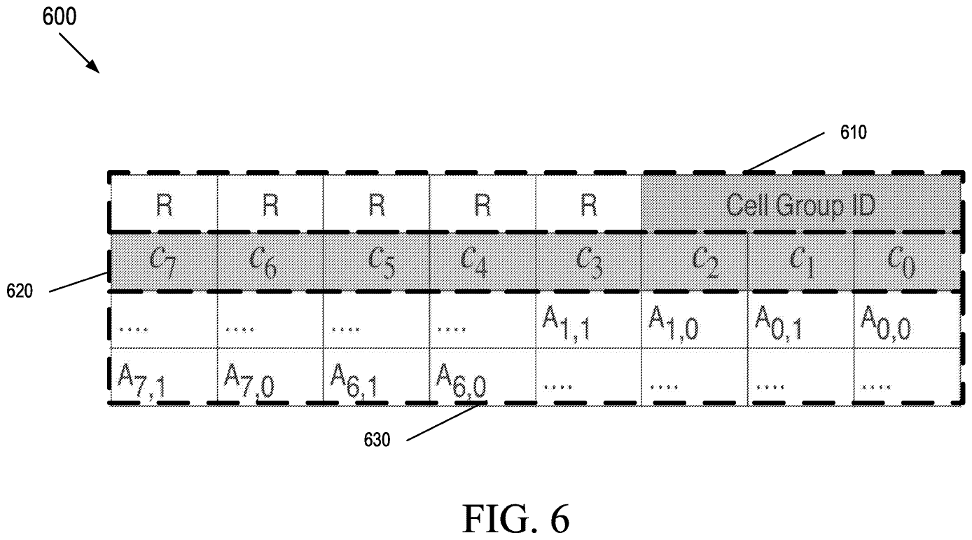

FIG. 6 shows a table 600 illustrating a MAC-CE configured to activate/deactivate PCells/SpCell CSI reports for candidate cells in a CG. In FIG. 6, up to two CSI reports and up to eight candidate cells are shown as being supported for a given CG.

In FIG. 6, a single CG CSI reports activation/deactivation the MAC-CE. In table 600, a MAC subheader 610 is shown with a Logical Channel ID (LCID) at a fixed size and may include fields including a “Cell Group ID,” a “candidate cell index,” and a “CSI Report Config ID.” In the MAC subheader 610, five fields are labeled as reserved (R) and three are labeled as “Cell Group ID.” The characteristics of the MAC subheader 610 may be similar to those discussed in

The “Cell Group ID” may indicate the identity of the CG in which the MAC-CE applies. Further, the “candidate cell index” may indicate the SCell “C” in the CG with an SCell index “i.” In this regard, Cᵢ=0 indicates the SCell with SCell index “i” for which the MAC-CE does not apply and Cᵢ=1 indicates the SCell with SCell index “i” for which the MAC-CE applies. The “candidate cell index” is shown in row 620 where all eight candidate cells are indexed from C₀ to C₇.

The “CSI Report Config ID” may indicate the activation/deactivation status of a specific CSI report of a series of CSI reports configured for the CG in accordance with the CSI report configuration. In rows 630, the “CSI Report Config ID” is shown indexed with values for “i” and “j” for a cell candidate cell “A.” In this regard, “i” is the SCell index shown in row 610 while “j” is the “j^{th}” PCell/SpCell report configured on the indicated candidate cell with the “candidate cell index” of “i.” The value of “j” may be j=0, . . . M−1, where the maximum number of reports “M” may be configured by RRC signaling or (pre-) configured via additional parameters dynamically modified and/or hard-coded in the specification. In any case, if the value of “M” is M=1, there is no need of the “CSI Report Config ID” field in MAC-CE and “candidate cell index.” The “CSI Report Config ID” is shown in rows 630 where all eight candidate cells are indexed for A_{i,j} from A_{0,0} to A_{7,1}.

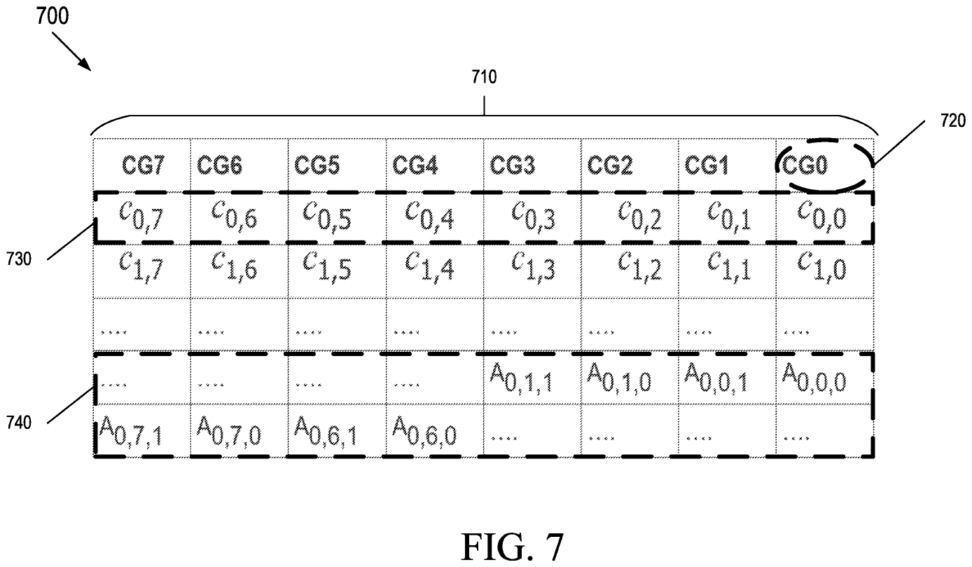

Turning to FIG. 7, shows a table 700 illustrating a MAC-CE configured to activate/deactivate PCells/SpCell CSI reports for candidate cells in multiple CGs. In FIG. 7, multiple CSI reports are shown as being supported for multiple CG.

In table 600, a MAC subheader 610 is shown with a Logical Channel ID (LCID) at a fixed size and may include fields including a “CG bitmap,” a “candidate cell index,” and a “CSI Report Config ID.” In the MAC subheader 710, eight fields are labeled as “CG” with an index of “i.” The characteristics of the MAC subheader 710 may be similar to those discussed in 3GPP TS 38.321.

The “CG bitmap” may indicate the identity of the CG with CG ID of index “i” for which the MAC-CE applies. Further, the “Candidate cell index” may indicate the SCell “C” in the CG with an SCell index “j” in a “CGᵢ.” In this regard, C_{i,j}=0 indicates the SCell with SCell index “j” for which the MAC-CE does not apply and C_{i,j}=1 indicates the SCell with SCell index “j” for which the MAC-CE applies. The “candidate cell index” is shown in row 730 where the candidate cells are indexed from C_{0,0} to C_{0,7}.

In one or more embodiments, the “CSI Report Config ID” may indicate the activation/deactivation status of the “k^{th}” CSI report of a series of CSI reports configured for the CGs in accordance with the CSI report configuration. In rows 740, the “CSI Report Config ID” is shown indexed with values for “i,” “j,” and “k” for a cell candidate cell “A.” In this regard, “i” is the identity of the CG and “j” is the SCell index shown in row 730. In row 740, the “k” is the “k^{th}” PCell/SpCell report configured on the indicated candidate cell with the “Candidate cell index” of “j.” The value of “j” may be j=0, . . . M−1 in a given CGᵢ, where the maximum number of reports “M” may be configured by RRC signaling or (pre-) configured via additional parameters dynamically modified and/or hard-coded in the specification. In any case, if the value of “M” is M=1, there is no need of the “CSI Report Config ID” field in MAC-CE and “Candidate cell index.” The “CSI Report Config ID” is shown in rows 740 where all candidate cells are indexed for A_{i,j,k} from A_{0,0,0} to A_{0,7,1}. An enhancement provided by the bitmap is that a selection of a given CGᵢ may provide association to other instances of the same CG indexed with a same value of “i,” as shown by selection 720.

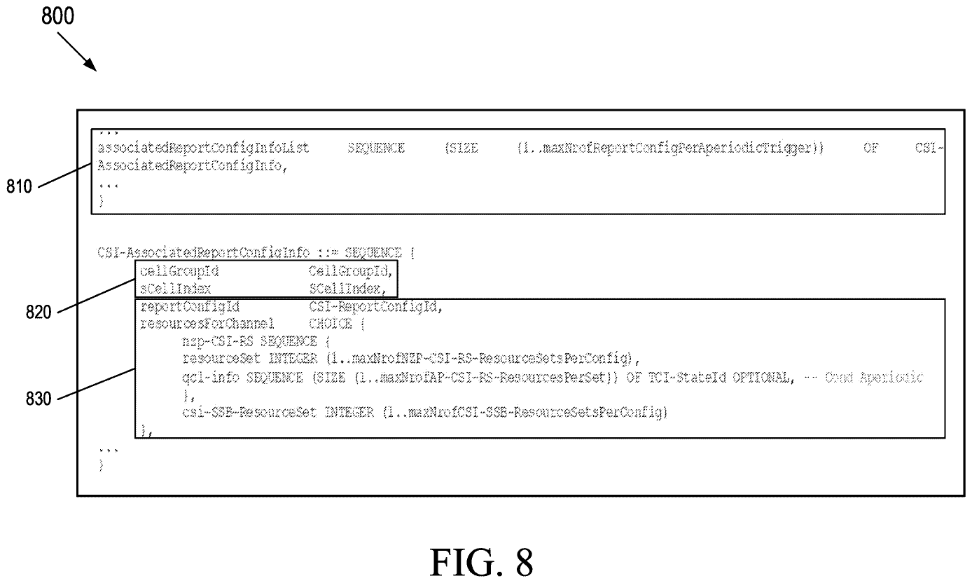

In FIG. 8, a code example 800 illustrates a structure to configure CSI-triggering. In FIG. 8, multiple blocks 810-830 are shown where the ICBM framework is modified such that the aperiodic CSI reports for cells in candidate CGs are triggered by a CSI request field in the DCI transmitted on the active serving cell.

In one or more embodiments, CSI triggering states may be used with information element CSI-AperiodicTriggerStateList in the serving cell. These triggering states may be associated with one or more CSI reports configured for deactivated cells in a candidate CG.

In one or more embodiments, the block 810 indicates an ongoing configuration structure. Further, the block 820 includes additional information elements introduced in this disclosure. These additional information elements include cellGroupId and sCellIndex. As described above, a given CG is identified in cellGroupId. In cellGroupId, a value 0 identifies a master cell group. Other values may identify secondary cell groups. The sCellIndex is used to identify an SCell or a PSCell. Block 830 shows that reportConfigId runs to identify a measurement reporting configuration for aperiodic CSI reports.

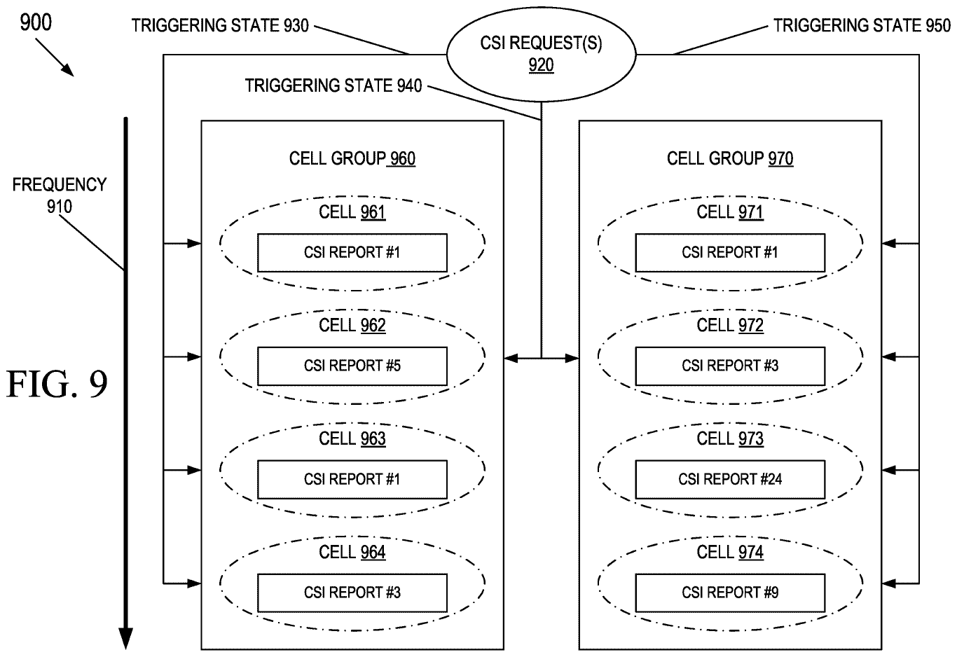

Turning to FIG. 9, shows a diagram 900 in which candidate cells in a CG are associated using triggering states. These triggering states are shown to be between 3-bits long starting at “000” and ending at “111.” In some embodiments, states “001,” “010,” “011,” “100,” “101,” “110,” and “111” are used as CSI triggering states. In FIG. 9, triggering states 930-950 may be any three triggering states from the aforementioned CSI triggering states. In a way of a non-limiting example, triggering state 930 may be equal to “001,” triggering state 940 may be equal to “010,” and triggering state 950 may be equal to “011.”

As described in reference to FIG. 8, these triggering states may be configured for the activation/deactivation of candidate cells across a same CG or different CGs. In diagram 900, cell group 960 and cell group 970 may be target CGs including deactivated candidate cells 961-964 and deactivated candidate cells 971-974, respectively. The deactivated candidate cells include individual CSI reports and increase in frequency 910 as their reference numbers increase. For example, a frequency of cell 961 is lower than that of cell 964. Each deactivated candidate cell is shown to include a specific report for which the given cell is (pre-)configured. In cell group 960, cells 961-964 include CSI reports #1, #5, #1, and #3, respectively. In cell group 970, cells 971-974 include CSI reports #1, #3, #24, and #9, respectively.

In the event that the triggering states 930-950 are requested among multiple CSI requests 920, the CSI triggering state “001” in DCI transmitted on a serving cell may be used to trigger CSI reports #1, #5, #1, and #3 on deactivated candidate cells 961-964 in cell group 960. Further, the triggering state “010” in DCI transmitted on a serving cell may be used to trigger CSI reports #1, #3, #24, and #9 on deactivated candidate cells 971-764 in cell group 970. In the CSI triggering state “011” in DCI transmitted on a serving cell may be used to trigger CSI reports #5 and #3 on deactivated candidate cell 962 of cell group 960 and candidate cell 972 of cell group 970.

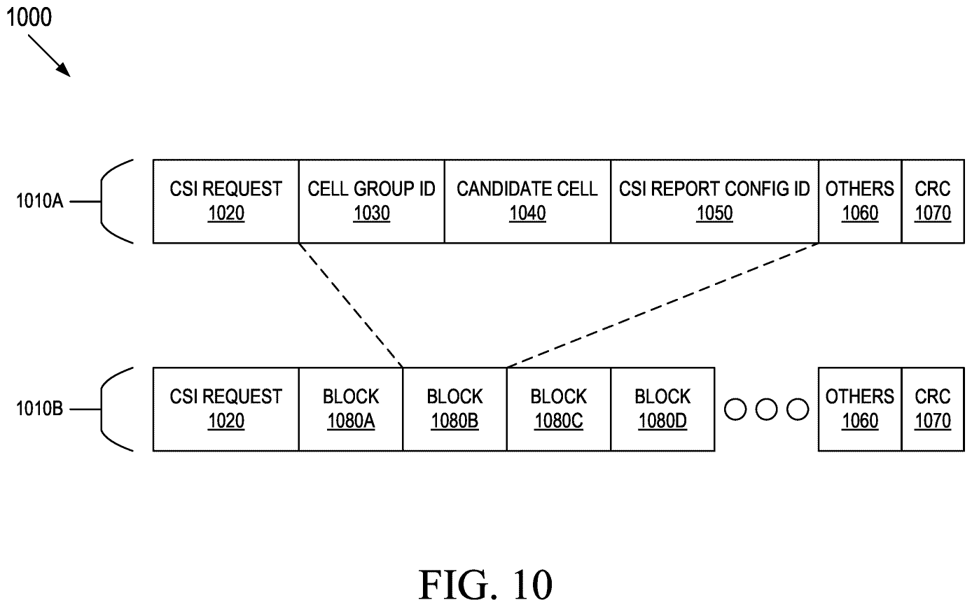

Turning to FIG. 10, diagram 1000 shows examples of DCI formats used for triggering aperiodic CSI reports on cells of one or more candidate CGs. The diagram 1000 includes at least two formats 110A and 1010B. A first format 1010A includes a CSI request 1020, the Cell Group ID 1030, at least one candidate cell 1040, the CSI Report Config ID 1050, other or additional fields 1060 and a cyclic redundancy check (CRC) 1070. A second format 1010B includes the CSI request 1020, multiple information blocks (i.e., numbered blocks 1080A-1080D), other or additional fields 1060 and a cyclic redundancy check (CRC) 1070. In the second format 1010B, each block may be configured to include each of the Cell Group ID 1030, at least one candidate cell 1040, and the CSI Report Config ID 1050 to trigger CSI reporting across multiple CGs.

In one or more embodiments, the DCI Format may be used for scheduling PDSCH or PUSCH or without data scheduling. The physical resource used to transmit the triggered CSI reports maybe defined depending on the channel being used. Using the PUCCH resource, the PUCCH resource on the serving cell for CSI reports maybe provided by the DCI, which may be selected from multiple PUCCH resources configured by RRC signaling. In this regard, the CSI reports may be triggered by DCI scheduling PDSCH or without data scheduling. In some embodiments, the CSI reporting is triggered in a PUSCH resource multiplexed with the scheduled uplink data. The PUSCH resource and the MCS may be provided by the scheduling DCI.

In the first format 1010A and the second format 1010B, the specific information is transmitted by means of the given format. In some embodiments, the “CSI Report Config ID” field indicates the triggering status of the “k^{th}” aperiodic CSI report configured on the indicated candidate cell. A bitmap of a CG is included in each of the blocks 1080A-1080D of the second format 1010B.

In one or more embodiments, the formats 1010A and 1010B may be introduced to trigger the aperiodic CSI reports for deactivated candidate cells in one or more CGs (i.e., Multi-CG). In the formats, a computation time may be used for L1-RSRP measurements on a candidate cell. Given the fact that candidate cell is still in deactivated state, a specific time for CSI reporting may be introduced as a CSI report processing time for deactivated candidate cell T_{CSI,1}. In some embodiments, when the CSI request field on a DCI triggers one or more CSI reports on PUSCH, the terminal may provide a valid CSI report for the triggered report starting no earlier than T_{CSI,1} relative to the last symbol of the PDCCH triggering the CSI reports. In other embodiments, the terminal may ignore the triggering if the first symbol of the PUCCH or PUSCH resource to carry the CSI reporting starts earlier than T_{CSI,1}.

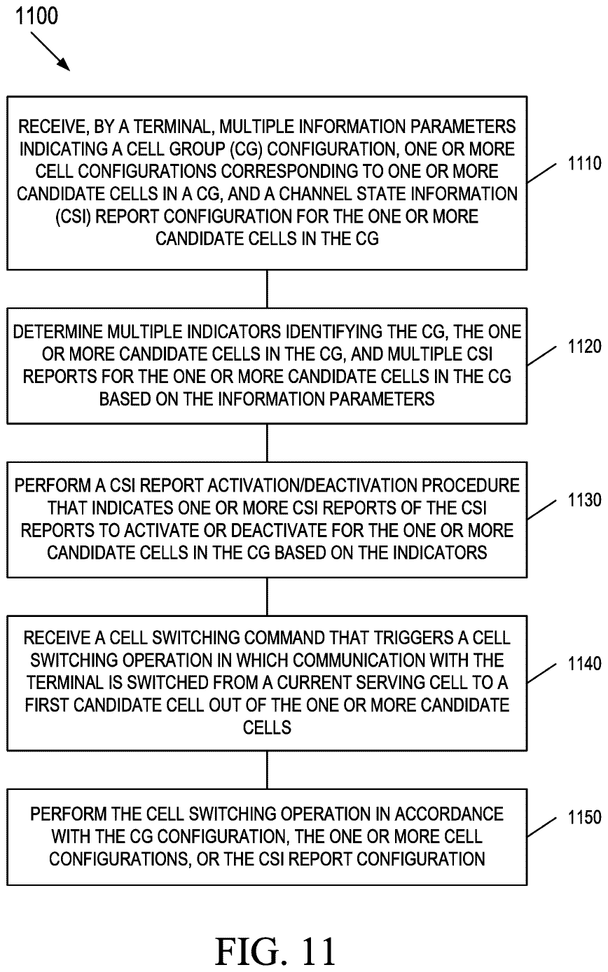

FIG. 11 illustrates a flowchart in which method 1100 is performed in a sequence of blocks. The method 1100 may be performed by a terminal transmitting or receiving communications with one or more cells grouped in CGs, in accordance with one or more embodiments. At 1110, the flowchart begins with a terminal configured to receive multiple information parameters (i.e., configuration parameters) indicating a CG configuration, one or more cell configurations corresponding to one or more candidate cells in a CG, and a CSI report configuration for the candidate cells in the CG.

At 1120, the flowchart continues with the terminal configured to determine multiple indicator identifying the CG, the one or more candidate cells in the CG, and multiple CSI reports for the one or more candidate cells in the CG based on the information parameters. As defined above, the identifier of the CG may be an information element CellGroupID, the identification of the individual cells may be performed via SCellIndex or other indexing, and the CSI reports may be indicated using information element CSI-MeasConfig.

At 1130, the flowchart continues with the terminal configured to perform a CSI report activation/deactivation procedure that indicates one or more CSI reports to activate or deactivate for the one or more candidate cells in the CG based on the indicators. As defined above, the CSI report activation/deactivation procedure may be configured and reported in the manner described in reference to FIGS. 5-10. Further, the CSI report activation/deactivation procedure may be configured and reported in the manner described in reference to 3GPP TS 38.212, TS 38.214, TS 38.215, and TS 38.331.

At 1140, the flowchart continues with the terminal configured to receive a cell switching command that triggers a cell switching operation in which communication with the terminal is switched from a current serving cell to a first candidate cell out of the one or more candidate cells. As defined above, the cell switching command may triggers the cell switching operation in which the terminal may perform the cell switching operation in accordance with the CG configuration, the individual cell configurations, or the CSI report configuration. The CSI report activation/deactivation procedure may include activating one or more CSI resource sets that are associated with the CSI report configuration.

The flowchart ends at 1150 where the terminal performs the cell switching operation in accordance with the CG configuration, the one or more cell configurations, or the CSI report configuration. The cell switching operation is performed in accordance with the examples described in reference to FIGS. 6-10.

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A terminal comprising:
a receiver configured to receive a plurality of information parameters indicating a cell group (CG) configuration, one or more cell configurations corresponding to one or more candidate cells in the CG, and a Channel State Information (CSI) report configuration for the one or more candidate cells in the CG; and
a processor configured to:
determine a first plurality of indicators identifying the CG, the one or more candidate cells in the CG, and a plurality of CSI reports for the one or more candidate cells in the CG based on the plurality of information parameters, and
perform a CSI report activation/deactivation procedure that indicates one or more CSI reports of the plurality of CSI reports to activate or deactivate for the one or more candidate cells in the CG based on the first plurality of indicators.

2. The terminal of claim 1, wherein:
the receiver is further configured to receive a cell switching command that triggers a cell switching operation, in which communication with the terminal is switched from a current serving cell to a first candidate cell out of the one or more candidate cells, and
the processor is further configured to perform the cell switching operation in accordance with the CG configuration, the one or more cell configurations, or the CSI report configuration.

3. The terminal of claim 2, wherein:
the CSI report activation/deactivation procedure comprises activating one or more CSI resource sets that are associated with the CSI report configuration.

4. The terminal of claim 3, wherein:
the one or more candidate cells are part of a same CG,
the CSI report configuration comprises one or more CSI reports of the plurality of CSI reports that are associated with a corresponding CSI resource set on the one or more candidate cells, and
a Medium Access Control (MAC)-Control Element (CE) includes a second plurality of indicators used to activate or deactivate the one or more CSI reports associated with the one or more candidate cells in the same CG.

5. The terminal of claim 4, wherein the second plurality of indicators comprises:
a Cell Group ID that indicates an identity of the CG,
a candidate cell index that indicates a specific cell in the CG, and
a CSI report configuration ID that indicates an activation or a deactivation status of a specific CSI report of a series of CSI reports configured for the CG in accordance with the CSI report configuration.

6. The terminal of claim 3, wherein:
the one or more candidate cells are part of a plurality of CGs,
the CSI report configuration comprises one or more CSI reports that are associated with corresponding CSI resource sets on the one or more candidate cells, and
a Medium Access Control (MAC)-Control Element (CE) includes a second plurality of indicators used to activate or deactivate the one or more CSI reports associated with the one or more candidate cells in the plurality of CGs.

7. The terminal of claim 4, wherein the second plurality of indicators comprise:
a Cell Group bitmap that is a one-to-one mapping with a Cell Group ID from a plurality of Cell Group IDs, each Cell Group ID indicates an identity of a CG out of the plurality of CGs,
a candidate cell index that indicates a specific candidate cell within a C G in the plurality of CGs, and
a CSI report configuration ID that indicates an activation or a deactivation status of a specific CSI report of a series of CSI reports configured for the one or more candidate cells in the plurality of CGs in accordance with the CSI report configuration.

8. The terminal of claim 3, wherein the plurality of indicators comprise:
one or more CSI triggering states that indicate an activation or a deactivation of one or more CSI reports of the plurality of CSI reports corresponding to the one or more cells where the association between CSI triggering states and the one or more CSI reports is configured by Radio Resource Control (RRC) signaling.

9. The terminal of claim 3, wherein the plurality of indicators comprise:
information for triggering aperiodic CSI reports transmitted by terminal using a Physical Uplink Control Channel (PUCCH) resource or a Physical Uplink Shared Channel (PUSCH) resource.

10. The terminal of claim 9, wherein the information for triggering aperiodic CSI reports comprise:
an indication identifying that the one or more candidate cells are in one or more CGs, and
a CSI computation time indicating a processing time for at least one CSI report.

11. The terminal of claim 1, wherein:
at least one of the one or more candidate cells is a deactivated candidate cell.

12. The terminal of claim 1, wherein:
the CSI report configuration is a Layer 1 (L1) measurement configuration.

13. The terminal of claim 2, wherein:
the cell switching operation is a Layer 1 (L1)/Layer 2 (L2)-based cell switching procedure.

14.-24. (canceled)

25. An integrated circuit configured to cause a wireless device to perform the following operations:
receive, at a receiver of the wireless device, a plurality of information parameters indicating a cell group (CG) configuration, one or more cell configurations corresponding to one or more candidate cells in the CG, and a Channel State Information (CSI) report configuration for the one or more candidate cells in the CG;
determine a first plurality of indicators identifying the CG, the one or more candidate cells in the CG, and a plurality of CSI reports for the one or more candidate cells in the CG based on the plurality of information parameters, and
perform a CSI report activation/deactivation procedure that indicates one or more CSI reports of the plurality of CSI reports to activate or deactivate for the one or more candidate cells in the CG based on the first plurality of indicators.

26. The integrated circuit of claim 25, wherein:
the receiver is further configured to receive a cell switching command that triggers a cell switching operation, in which communication with the terminal is switched from a current serving cell to a first candidate cell out of the one or more candidate cells, and
the integrated circuit is further configured to cause the wireless device to perform the cell switching operation in accordance with the CG configuration, the one or more cell configurations, or the CSI report configuration.

27. The integrated circuit of claim 26, wherein:
the CSI report activation/deactivation procedure comprises activating one or more CSI resource sets that are associated with the CSI report configuration.

28. The integrated circuit of claim 27, wherein:
the one or more candidate cells are part of a same CG,
the CSI report configuration comprises one or more CSI reports of the plurality of CSI reports that are associated with a corresponding CSI resource set on the one or more candidate cells, and
a Medium Access Control (MAC)-Control Element (CE) includes a second plurality of indicators used to activate or deactivate the one or more CSI reports associated with the one or more candidate cells in the same CG.

29. The integrated circuit of claim 28, wherein the second plurality of indicators comprises:
a Cell Group ID that indicates an identity of the CG,
a candidate cell index that indicates a specific cell in the CG, and
a CSI report configuration ID that indicates an activation or a deactivation status of a specific CSI report of a series of CSI reports configured for the CG in accordance with the CSI report configuration.

30. A method, comprising:
receiving, at a receiver of a wireless device, a plurality of information parameters indicating a cell group (CG) configuration, one or more cell configurations corresponding to one or more candidate cells in the CG, and a Channel State Information (CSI) report configuration for the one or more candidate cells in the CG;
determining, by the wireless device, a first plurality of indicators identifying the CG, the one or more candidate cells in the CG, and a plurality of CSI reports for the one or more candidate cells in the CG based on the plurality of information parameters; and
performing, by the wireless device, a CSI report activation/deactivation procedure that indicates one or more CSI reports of the plurality of CSI reports to activate or deactivate for the one or more candidate cells in the CG based on the first plurality of indicators.

31. The method of claim 30, wherein:
the receiver is configured to receive a cell switching command that triggers a cell switching operation, in which communication with the wireless device is switched from a current serving cell to a first candidate cell out of the one or more candidate cells, and
the method further comprises: performing the cell switching operation in accordance with the CG configuration, the one or more cell configurations, or the CSI report configuration.
